(19) United States
(12) Patent Application Publication
(10) Pub. No.: US 2023/0120309 A1
(43) Pub. Date: Apr. 20, 2023

(54) SYSTEM AND METHOD OF REACTIVE SUGGESTIONS TO TEXT QUERIES

(71) Applicant: Johannes Hartz, Hamburg (DE)

(72) Inventor: Johannes Hartz, Hamburg (DE)

(73) Assignee: Quoori Inc., San Francisco, CA (US)

(21) Appl. No.: 17/503,614

(22) Filed: Oct. 18, 2021

(51) Int. Cl. G06F 16/332; G06F 40/274; G06F 16/338; G06F 16/33

(52) U.S. Cl. CPC G06F 16/3322; G06F 40/274; G06F 16/338; G06F 16/3344

(57) ABSTRACT

A system for providing reactive suggestions to text queries is provided comprising computer, client device, and application on the computer. The system receives notification of entry of a partial text string into a field of a client device. The system also accesses stored records describing behaviors and tendencies of a user of when previously accessing applications, functionalities, and data. The system also generates associations between the partial string and stored records, the associations describing linkages of the string with behaviors and tendencies described in the records. The system also ranks the associations by likelihood of matching the text string. The system also presents a first choice to the client device based on the rankings, the first choice when accepted by the client device invoking a first action suggested by the highest-ranked association. Based on receipt of the first choice, the system causes the client device to invoke the first action.

### FIELD OF THE INVENTION

The present disclosure is in the field of tools and utilities for computer users and users of mobile devices. More particularly, the present disclosure provides systems and methods of presenting a user who is entering a text string with suggested functionalities, applications, and data to assist the user in completing a desired action, the suggested material based on analysis of previous user behaviors and tendencies.

### BACKGROUND

Autocomplete is an established technology in the prior art that predicts the remainder of a word a user is typing. Autocomplete speeds up human-computer interactions when it correctly predicts the word a user intends to enter after only a few characters have been typed into a text input field. Traditional autocomplete may work best in domains with a limited number of possible words (such as in command line interpreters), when some words are much more common (such as when addressing an e-mail) or writing structured and predictable text (as in source code editors). Some autocomplete algorithms in the prior art learn new words after the user has written them a few times and can suggest alternatives based on the learned habits of the individual user.

In web browsers, autocomplete is done in the address bar (using items from the browser's history) and in text boxes on frequently used pages, such as a search engine's search field. Autocomplete for web addresses can be convenient because full web addresses are often long and difficult to type correctly.

In electronic mail programs, autocomplete is typically used to fill in e-mail addresses of intended recipients. Generally, there are a small number of frequently used e-mail addresses, hence it is relatively easy to use autocomplete to select among them. Like web addresses, e-mail addresses are often long, hence typing them completely is inconvenient.

In search engines, autocomplete user interface features provide users with suggested queries or results as they type their query into a search field. A challenge remains to search large indices or popular query lists in under a few milliseconds so that the user sees results pop up while typing.

In the prior art, autocomplete is limited to searching a certain database. The suggestions are resolved from searching through local files and documents and offering to open them.

For browsers, suggestions made by the prior art are usually websites that have been visited previously. For desktop operating systems, autocompleted suggestions in the prior art are again generally limited to opening local apps, files and documents.

### BRIEF DESCRIPTION OF THE FIGURES

FIG. 1 is a block diagram of a system of reactive suggestions to text queries in accordance with an embodiment of the present disclosure.

FIG. 2 is a listing of available actions of system of reactive suggestions to text queries in accordance with an embodiment of the present disclosure.

FIG. 3 is a listing of available entities of system of reactive suggestions to text queries in accordance with an embodiment of the present disclosure.

FIG. 4 is a sample interface of a system of reactive suggestions to text queries in accordance with an embodiment of the present disclosure.

FIG. 5 is another sample interface of a system of reactive suggestions to text queries in accordance with an embodiment of the present disclosure.

FIG. 6 is yet another sample interface of a system of reactive suggestions to text queries in accordance with an embodiment of the present disclosure.

### DETAILED DESCRIPTION

Systems and methods of reactive suggestions described herein receive entry of a partial text string and determine functionalities, applications, and stored files as potential search results to present for selection and execution while the user is still entering the text string. Standard keyboard input is supported by an intelligent partial query response shortcut function based on tracked and continually updated user behaviors and tendencies.

The system is adapted to user habits and circumstances depending on available applications, appointments, contacts, and stored files with increasing use. When the user uses the system, the system automatically tracks the usage information and adapts its behavior to a continually growing body of stored information based on the usage. For suggestions provided by the system which are used frequently, those suggestions will be presented to the user more often and higher up on the list of suggestions. Suggestions that are shown to the user frequently but not chosen by the user will be placed lower on the list and eventually be removed.

As a user enters input, the system returns matching reactive suggestions in real time to display and make eligible to the user for selection the possible actions the user may take with the given input. Instead of merely consulting a database for additional text that may complete the user's entry, the system searches for applications, functionalities, software accessories, calendar items, and contacts that may satisfy the user's intended result in entering the partial text string.

A user may, for example, begin by entering the text characters “ma” into a search field. Instead of merely accessing a database and returning the last three words the user typed beginning with “ma” that may, for example, be master, magnify, and marriage, the system analyzes the user's previous overall behavior for applications, utilities, and proper names that may include the string “ma.” The system examines much broader and deeper behaviors and tendencies of the user. This examination extends beyond text terms to applications, functionalities, files, and other media and stored items.

Based on the system's examination and analysis made of the user's previous behavior that includes the use of the string “ma,” the system may return “maps” to the user as an initial offering. This action may be a result of the system noting that the user frequently accesses an app, utility, or other functionality providing map and driving direction services. The system's action of reactively suggesting map as a function is done rapidly while the user is in the process of typing “ma” and gives the user the opportunity to select maps based on a simple action such as a single keystroke whereupon the mapping utility instantly is activated on the user's device.

The system may instead offer “mail” to the user as this application begins with the string “ma” and may be used frequently by the user. The system may alternatively offer contacts named Mark Smith or Douglas MacDonald and offer email, texting, social networking, or voice calling functionality to the user if the system detects that the user frequently contacts either of these people using one of these methods. Offering mail or offering one or both of these people as contacts may be presented as a second choice if the user does not select map and continues typing. When multiple options are presented, they are sorted by priority the system has derived from past behavior. Of course, the user upon entering third character after “ma” (which indicates that the user likely does not accept maps, mail, Mark Smith, or Dave MacDonald as offerings) will allow the system to rapidly narrow the field of choices the system can offer to the user.

It bears noting that while a single input of “ma” may be expanded to “Maps” or “Max Miller,” when the user enters partial input that indicates a certain domain of functionality (such as “call”), the system automatically limits the domain of possible future expansions. Therefore, for “call ma” it will only expand to “call Max Miller” but not “call Maps”. The system functions in this manner for all skills such that when a partial input indicates a subset of skills for usage, further auto-completions will be limited to those domains. For the above example, “open ma” will only result in “open Maps” and not “open Max Miller”. This is a differentiating factor from previous implementations. The system provided herein does not only auto-complete based on mapping string input but also actively restricts the domain to only present meaningful completions.

The system observes choices the user makes which may include instances of disregarding suggestions, actions which are effectively choices although they are not overt actions. With continued use, the system builds its own store of observed user behaviors and tendencies. The system relies on this store in making reactive suggestions as the user makes partial text entries into the system and the system attempts to project what the user is trying to access. The system effectively learns the user's tendencies and uses intelligence to make associations between text entries and behaviors and tendencies that arise from those keyboard actions. The system, based on its past observations and analysis, surmises user intent and provides the user suggestions, relieving the user of entering further text or doing more searching.

Actions available for reactive suggestions, for example the aforementioned applications or functionalities of maps, mail, or the two human contacts, are packaged into different modules. Each module, which may be referred to as a skill, contributes a set of commands and/or entities it can match on. This way the system is modular and extendable. Managers of the system can add and remove skills from the system to increase or decrease possible suggestions and subsequent actions. The system automatically integrates each new skill that is installed and offers additional suggestions for the newly added skill. Conversely, if a skill is removed from the system there will not be any further suggestions for its actions. Skills can be added and removed in a modular way to personalize the system and its behavior.

Individual functions such as calendar, notes, electronic mail, and system settings each have their own modules that may be added or removed from the system. An organization, such as a business corporation or government body may offer the system to its employees to support employee productivity and influence employee conduct. The organization, as administrator of the system, may offer only certain functions for employee access while excluding other functions. As large organizations oversee employees' online activities, the system may offer such organizations an element of control over employee network use which if unchecked can be excessive and detrimental to productivity as well as expose the organization to potential liability.

In embodiments such as those described briefly above, the system may be provided as an enterprise service. The functionality may reside on enterprise servers or even in a cloud configuration. Search queries entered as text strings into search fields in client or user devices may be sent to remote servers housing the system, the remote servers possibly in a cloud configuration. Results of such queries would be sent directly back to the client devices and/or local servers providing local management of the system for forwarding to requesting client devices.

In other embodiments, the system may be provided as a personal service that fully executes on a user's own computer. In that instance, the user may have complete control over the modules he/she wants to have available in the locally stored and executing system. Alternatively in this embodiment wherein the entire system is stored and executes locally on a user's device, the initial modules for the system may still be supplied by a management function and the system, while completely local, may still be overseen by management software across an enterprise network.

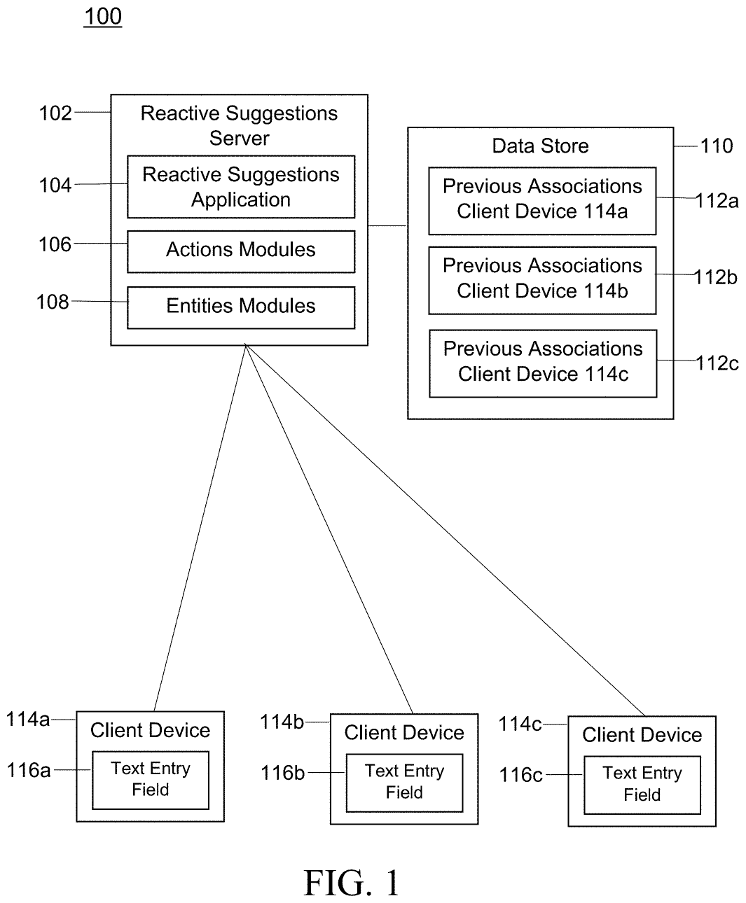

Turning to the figures, FIG. 1 is a block diagram of a system of reactive suggestions in accordance with an embodiment of the present disclosure. FIG. 1 depicts components and interactions of a system 100 comprising a reactive suggestions server 102 and a reactive suggestions application 104, referred to for brevity hereafter as the server 102 and the application 104, respectively.

The server 102 is at least one physical computer. When the server 102 comprises multiple physical computers, the computers may be situated at more than one geographic location. The application 104 executes on the server 102 and provides most of the systems and methods provided herein. While system 100 is presented herein as executing on the server 102 that is a different component from client devices that may be entering search text strings, in many embodiments the functionality provided herein may execute locally on client devices.

The system 100 also comprises actions modules 106 and entities modules 108. Together, these modules 106, 108 provide alternatives presented by the application 104 to the user based on partial text entry and associations made by the application 104 as described herein. The application 104 draws upon the modules 106, 108 after the application 104 has performed its analysis of partially entered text by the user against previous behaviors and associations of those behaviors with previous choices made by the users.

The modules 106, 108 comprise the applications, functionalities, and data described above and are the various alternative actions and data choices made available once the application 104 analyses a text entry and draws upon its store of previous associations of text entries and corresponding selections made by the user.

As noted, modules 106, 108 may be added and removed by the system 100. An employer providing services as described herein to employees does not necessarily want employees to have access to modules 106, 108 that make it easier for employees to freely “surf” the Internet. The employer may choose to provide only certain modules 106, 108 that are useful in employees performing their work duties. The employer may add or remove modules 106, 108 at its option. The services provided by systems and methods described herein may in embodiments be offered on a commercial basis.

The system 100 also comprises the data store 110 which contains previous associations made by the application 104 for various users of the system. The associations are made based on observation and analysis of user behaviors and tendencies. The application 104 continually observes the user's actions and choices made when entering text for searches as well as other keyboard actions and actions associated with other input devices. For each user, the application 104 over time effectively learns the user's tendencies and can therefore refine its decision-making with each observed user action.

The system 100 also comprises client devices 114a-c, each of which makes text entries via text entry fields 116a-c, respectively. In an embodiment, the client devices 114a-c are desktop computers used by employees in an organization that on each working day log into an enterprise network which includes the server 102. The functionality provided by systems and methods provided herein may be provided to the client devices 114a-c as a desktop application. The client devices 114a-c may also be smartphones, tablet devices, or laptop devices, especially those with touch screen capabilities.

The system 100 also comprises stored files for previous associations 112a-c that are maintained by the data store 110. Such stored files 112a-c may be maintained separately for each client device 114a-c. In FIG. 1, such files are depicted as previous associations client device 114a, previous associations client device 114b, and previous associations client device 114c and they correspond to client devices 114a-c, respectively. The application 104 may update these files 114a-c on a regular basis with each observation and analysis of user behavior in entering text searches into the users' respective client device 114a-c.

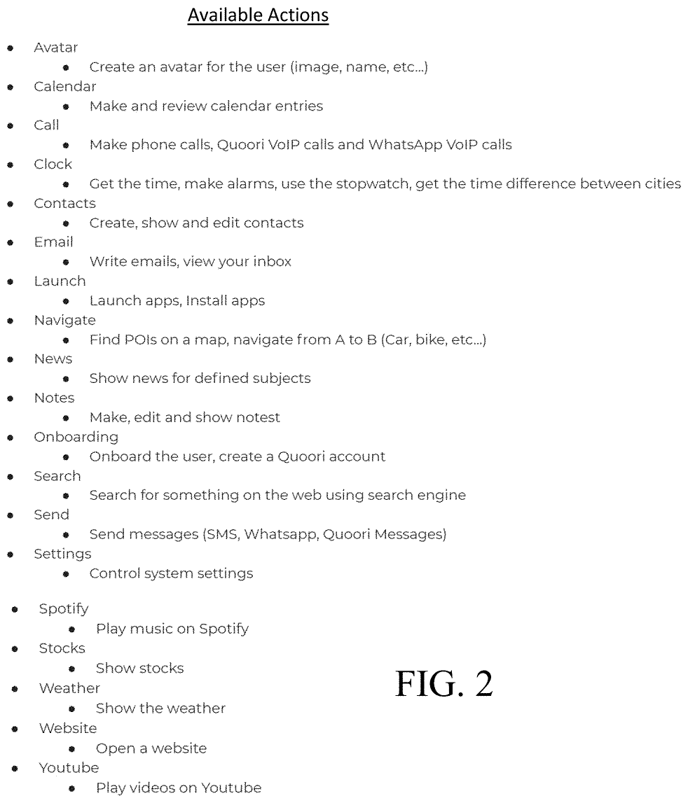

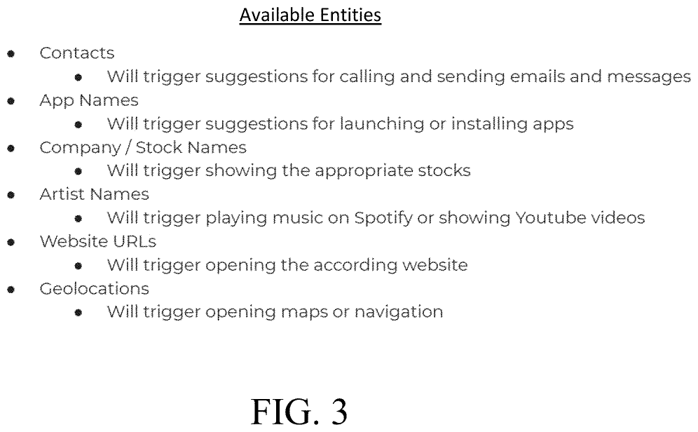

FIG. 2 is a listing of available actions and FIG. 3 is a listing of available entities. These actions are contained within and provided by the actions module 106 and the entities module 108 of the system 100. The application 104 invokes these actions and entities based on its analysis of text entered into text entry fields 116a-c by users of client devices 114a-c.

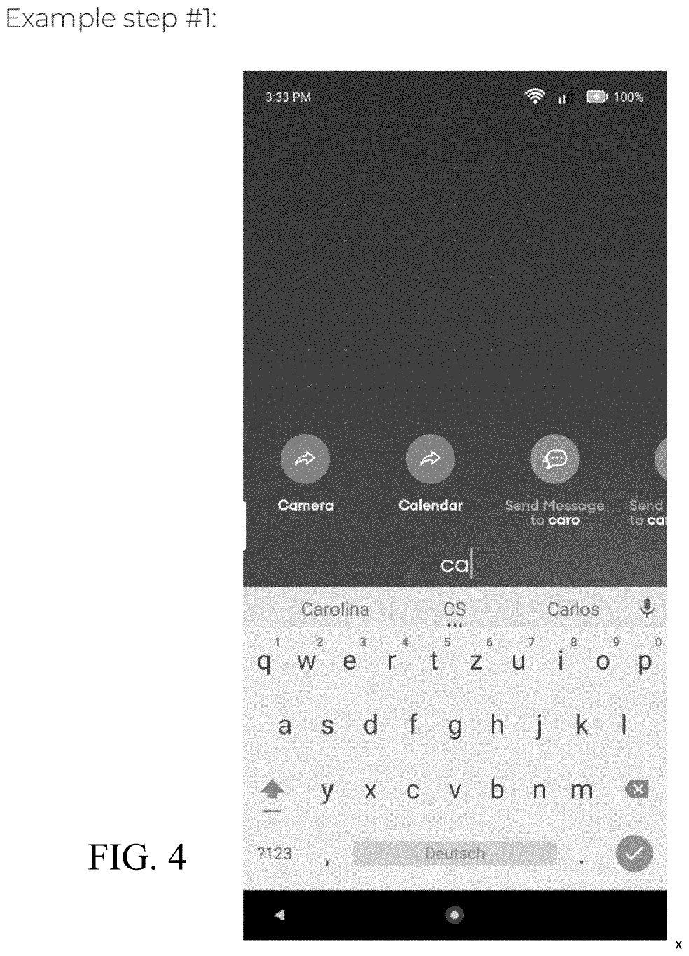

FIG. 4 through FIG. 6 illustrate steps in a typical use of systems and methods provided herein. FIG. 4 through FIG. 6 provide example screenshots from a mobile device.

In FIG. 4, the user has started typing “ca” and is still typing. For the partial input “ca” the application 104 already returns matching suggestions for opening the camera, opening the calendar or sending a message to a contact named “Caro”. Selecting such a suggestion will result in the application 104 executing the action. More suggestions are on the right but not visible in the FIG. 4. Reactive suggestions are generally sorted from highest to lowest priority.

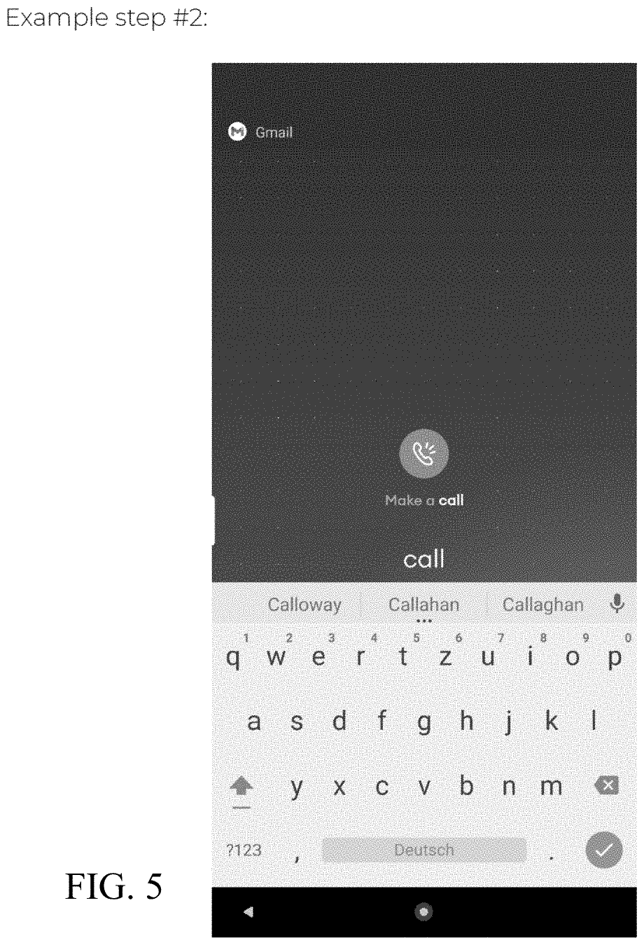

In FIG. 5, the user continues typing and the input becomes “call”. In real time the application 104 narrows down the suggestions to appropriate matches and offers to make a call.

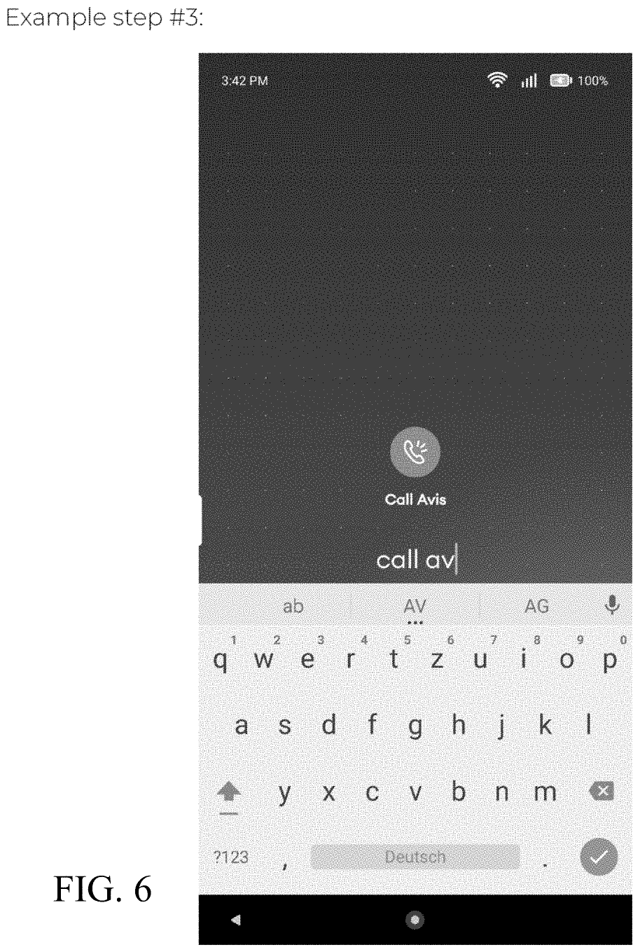

In FIG. 6, the user has continued typing to specify whom to call. For the given input and the existing phonebook on the client device 114a-c, the application 104 returns a suggestion for calling Avis. Perhaps in the past the user has rented vehicles from Avis. This type of information may be available in the data store 110.

For each input the user enters into his/her text entry field 116a-c, the application 104 returns reactive suggestions while the input is still ongoing. There are several different cases of this described below.

1. Partial Command Matches
For input that cannot be mapped directly to an action the system will use behavior that attempts to predict what the user seeks to accomplish. In the example above, the input “ca” will be extended by the application to “call”, “camera”, “calendar”, and so forth. Then the system offers suggestions for those accordingly. The user can then choose which action to take from the different suggestions. Also, this action can be combined for several pieces of the input, for example “ca ca” will be extended to “call caro”. Action and entities are combined here.

2. Full Command Matches
If the system can fully match an action, it will only offer that specific action to the user.

3. Entity Matches
The system supports not only commands but also entities that can be given as input. Again, both partial and full matches are supported. This includes for example contact names (“ca” can be expanded to “caro”), app names (“sl” will be expanded to “slack”), company name, artist names and others.

4. Fallback
For input the system cannot match anything on (like “xyzxyzxyz”) it will offer fallback suggestions like “Search for ‘xyzxyzxyz’ on the internet”, “Send a message ‘xyzxyzxyz’ to someone” or “Create a note ‘xyzxyzxyz’”.

Systems and methods of reactive suggestions provided herein allow for deep linking into functionality as described above. Executing on suggestions provided by the application 104 may result in such different actions as making a call, visiting a website, changing a system setting, sending an email or showing current stock prices as described above. Triggering a multitude of different actions from incomplete input is not possible with implementations provided by the prior art which, as noted, searches only specific databases but not generic system functionality.

Systems and methods of reactive suggestions are fully modularized and readily extendible. For other AI-assistants of the prior art, functionality is centralized in some apps. For reactive suggestions provided herein, each alternative provided by the application 104 may contribute a unique set of suggestions and actions.

Systems and methods of reactive suggestions may be provided as a feature of the Quoori Concierge AI Assistant provided by Quoori Inc. Reactive suggestions show up in real time while the user is entering text into the Concierge.

System and methods provided herein are fully decentralized and can be opened to third party developers to add skills to a repository offered by Quoori. From a software engineering perspective, each skill is its own program which can be added and removed with the system adapting accordingly.

Some items of the prior art will offer that for an application that is already installed, given a certain search query, the prior art will crawl RSS-feeds associated with that application and attempt to find a match. The prior art will crawl content that the subject application can provide. If hits occur, it will offer to open that content through the subject installed application.

Systems and methods of reactive suggestions provided herein do not offer matching by content. Rather, systems and methods provided herein enable a developer define terms (both statically and dynamically) that will trigger a match on a certain application or a sub-functionality of the application. Systems and methods provided herein offer Natural Language Processing (NLP) functionality to widen the scope of possible hits on an application. The visual representation of a reactive suggestion provided herein may be an icon together with an explanatory text. This may be commercially referred to as a “Jewel”.

The present disclosure is not concerned with RSS-Feeds. Further, some implementations in the prior art only offer to open installed third party applications whereas in the present disclosure, opening installed third party applications is just part of the functionality. With the NLP and skill framework provided herein, systems and methods also offer detailed actions (“Send an email to John”) instead of just opening the email application. Systems and methods of reactive suggestions provided herein also offers to install applications.

Additional entities not mentioned above or listed in the figures include electronic mail addresses previously communicated with and Internet web addresses (Uniform Resource Locators) previously accessed on the user's device.

In an embodiment, a system for providing reactive suggestions to text queries is provided. The system comprises a computer, a client device, and an application executing on the computer. The system receives notification of entry of a partial text string into a field of a client device. The system also accesses stored records describing behaviors and tendencies of a user of the client device when previously accessing applications, functionalities, and data. The system also generates associations between the partial string and the stored records, the associations describing linkages of the partial text string with behaviors and tendencies described in the records. The system also ranks the associations by likelihood of matching the text string. The system also presents a first choice to the client device based on the rankings, the first choice when accepted by the client device invoking a first action suggested by the highest-ranked association. Based on receipt of the first choice, the system also causes the client device to invoke the first action. Therein the system adjusts generation of associations and rankings of associations based on repeated use of the system.

Actions comprising at least the first action comprise at least one of executing an application, activating a functionality, and accessing data suggested by the associations described in choices. Functionalities comprise at least one of calendar access, Internet web search, accessing of contact lists, and accessing system settings. Specific applications, specific functionalities, and specific data accesses made available by the system are modular and are expressly designated as available for presentation as choices to the client device. The system accepts added specific applications, specific functionalities, and specific data accesses for inclusion as choices. The computer observes entry of additional text into the field beyond entry of the partial text, the additional text extending the partial text string and indicating nonacceptance of the first choice by the client device. Based on the observation, the system accesses further stored records, generates further associations and rankings, presents a second choice based on the further associations and rankings, and based on acceptance of the second choice by the client device, causes invocation of a second action by the client device. The application alternatively executes on the client device.

In another embodiment, a method of providing reactive suggestions to text queries is provided. The method comprises a computer accessing a plurality of command functionality modules based on receiving a text string into a field. The method also comprises the computer accessing a plurality of application and content entity modules based on receiving the text string. Based on the computer generating associations of the text string with stored files describing past user behaviors, the method also comprises the computer searching the modules for at least partial matches of the associations and modules. The associations suggest the modules. The method also comprises the computer, based on presenting and receiving acceptance of a first module, tone of invoking a first functionality and accessing a first stored content entity associated with the first module. The method also comprises the computer receiving access to specific applications, specific functionalities, and specific data that are expressly designated as available for presentation as reactive suggestions in response to the text string. The method also comprises the computer observing entry of additional text into the field, the additional text extending the partial text string and indicating nonacceptance of the first module. The method also comprises the computer, based on the observation, accessing further stored files, generating further associations, and presenting a second module based on the further associations. The method also comprises the computer, based on receipt of acceptance of the second choice, one of invoking a second functionality and accessing a second stored entity associated with the second module. The method also comprises the computer adjusting generation of associations based on analysis of repeated receipts of text strings into the field.

In yet another embodiment, a method of building a utility providing reactive suggestions to observed text search strings is provided. The method comprises a computer observing and recording selections made during entries of text search strings. The method also comprises the computer loading modules enabling invocation of specific applications, functionalities, and data based on entry of partial search strings. The method also comprises the computer detecting entry of a text string and associating the text string with a first functionality. The method also comprises the computer determining that a module is not loaded for the first functionality and acquiring and loading a module for the first functionality. The method also comprises the computer associating text strings and corresponding observed and recorded selections to build a store of associations to draw upon when analyzing future text strings.

Selections made during entries of text strings comprise selections of suggested responses to entered text strings. The method also comprises the computer removing previously loaded modules. The method also comprises the computer, upon alternatively determining that a module is loaded for a specific one item of content comprising at least one of an application, functionality, and item of data sought by the text string, draws upon the module and presents it for one of acceptance and non-acceptance. The method also comprises the computer, upon receiving non-acceptance of the item of content as indicated by further entry of text beyond the string, presents another item of content for one of acceptance and non-acceptance.

What is claimed is:

1. A system for providing reactive suggestions to text queries, comprising:
a computer;
a client device; and
an application executing on the computer that:
receives notification of entry of a partial text string into a field of a client device,
accesses stored records describing behaviors and tendencies of a user of the client device when previously accessing applications, functionalities, and data,
generates associations between the partial string and the stored records, the associations describing linkages of the partial text string with behaviors and tendencies described in the records;
ranks the associations by likelihood of matching the text string,
presents a first choice to the client device based on the rankings, the first choice when accepted by the client device invoking a first action suggested by the highest-ranked association, and
based on receipt of the first choice, causes the client device to invoke the first action
wherein the system adjusts generation of associations and rankings of associations based on repeated use of the system.

2. The system of claim 1, wherein actions comprising at least the first action comprise at least one of executing an application, activating a functionality, and accessing data suggested by the associations described in choices,

3. The system of claim 1, wherein functionalities comprise at least one of calendar access, Internet web search, accessing of contact lists, and accessing system settings.

4. The system of claim 1, wherein specific applications, specific functionalities, and specific data accesses made available by the system are modular and are expressly designated as available for presentation as choices to the client device.

5. The system of claim 1, wherein the system accepts added specific applications, specific functionalities, and specific data accesses for inclusion as choices.

6. The system of claim 1, wherein the computer observes entry of additional text into the field beyond entry of the partial text, the additional text extending the partial text string and indicating nonacceptance of the first choice by the client device.

7. The system of claim 6, wherein based on the observation, the system accesses further stored records, generates further associations and rankings, presents a second choice based on the further associations and rankings, and based on acceptance of the second choice by the client device, causes invocation of a second action by the client device.

8. The system of claim 1, wherein the application alternatively executes on the client device.

9. A method of providing reactive suggestions to text queries, comprising:
a computer accessing a plurality of command functionality modules based on receiving a text string into a field;
the computer accessing a plurality of application and content entity modules based on receiving the text string;
based on the computer generating associations of the text string with stored files describing past user behaviors, the computer searching the modules for at least partial matches of the associations and modules, wherein the associations suggest the modules;
the computer, based on presenting and receiving acceptance of a first module, one of invoking a first functionality and accessing a first stored content entity associated with the first module.

10. The method of claim 9, further comprising the computer receiving access to specific applications, specific functionalities, and specific data that are expressly designated as available for presentation as reactive suggestions in response to the text string.

11. The method of claim 9, further comprising the computer observing entry of additional text into the field, the additional text extending the partial text string and indicating nonacceptance of the first module.

12. The method of claim 11, further comprising the computer, based on the observation, accessing further stored files, generating further associations, and presenting a second module based on the further associations.

13. The method of claim 12, further comprising the computer, based on receipt of acceptance of the second choice, one of invoking a second functionality and accessing a second stored entity associated with the second module.

14. The method of claim 9, further comprising the computer adjusting generation of associations based on analysis of repeated receipts of text strings into the field.

15. A method of building a utility providing reactive suggestions to observed text search strings, comprising:
a computer observing and recording selections made during entries of text search strings;
the computer loading modules enabling invocation of specific applications, functionalities, and data based on entry of partial search strings;
the computer detecting entry of a text string;
the computer associating the text string with a first functionality;
the computer determining that a module is not loaded for the first functionality; and
the computer acquiring and loading a module for the first functionality.

16. The method of claim 15, further comprising the computer associating text strings and corresponding observed and recorded selections to build a store of associations to draw upon when analyzing future text strings.

17. The method of claim 15, further comprising the selections made during entries of text strings comprising selections of suggested responses to entered text strings.

18. The method of claim 15, further comprising the computer removing previously loaded modules.

19. The method of claim 15, further comprising the computer, upon alternatively determining that a module is loaded for a specific one item of content comprising at least one of an application, functionality, and item of data sought by the text string, draws upon the module and presents it for one of acceptance and non-acceptance.

20. The method of claim 19, further comprising the computer, upon receiving non-acceptance of the item of content as indicated by further entry of text beyond the string, presents another item of content for one of acceptance and non-acceptance.
